(19) United States
(12) Patent Application Publication
(10) Pub. No.: US 2012/0327920 A1
(43) Pub. Date: Dec. 27, 2012

(54) METHODS TO ENHANCE COEXISTENCE WITH LOW ENERGY WIRELESS NETWORKS

(75) Inventors: Ariton E. XHAFA, Plano, TX (US); Yanjun Sun, Richardson, TX (US)

(73) Assignee: Texas Instruments Incorporated, Dallas, TX (US)

(21) Appl. No.: 13/526,644

(22) Filed: Jun. 19, 2012

Related U.S. Application Data
(60) Provisional application No. 61/501,474, filed on Jun. 27, 2011.

(51) Int. Cl. H04W 4/00

(52) U.S. Cl. 370/338

(57) ABSTRACT

Disclosed implementations address the coexistence problem of wireless local area network (WLAN) and Bluetooth Low Energy (BLE) technologies on the same device. For example, an apparatus includes a WLAN controller configured to cause a wireless transceiver module to send and receive packets over a wireless medium. A second controller is coupled to the WLAN controller and also configured to cause the wireless transceiver module to send and receive packet. The second controller informs the WLAN controller that the second controller is going to cause an advertising packet to be transmitted by the wireless transceiver module. The WLAN controller responds by causing a first protection packet to be transmitted by the wireless transceiver module, said first protection packet causes all wireless devices receiving the protection packet to inhibit use of the wireless medium during a timer period which includes the advertising packet. Other embodiments are disclosed as well.

### CROSS-REFERENCE TO RELATED APPLICATION

The present application claims priority to U.S. Provisional Patent Application No. 61/501,474 filed on Jun. 27, 2011 and titled “Methods to Enhance Coexistence with Low Energy Wireless Networks”, which is incorporated herein by reference.

### BACKGROUND

A variety of wireless protocols are available including, for example, the IEEE 802.11x family of protocols, Bluetooth, WiMAX, Wireless USB, etc. However, incorporating two or more wireless protocols in one device (e.g., smart phone, computer) may cause interference and saturation problems.

### SUMMARY

Disclosed implementations address the coexistence problem of wireless local area network (WLAN) and Bluetooth Low Energy (BLE) technologies on the same device. For example, an apparatus includes a WLAN controller configured to cause a wireless transceiver module to send and receive packets over a wireless medium. A second controller is coupled to the WLAN controller and also configured to cause the wireless transceiver module to send and receive packet. The second controller informs the WLAN controller that the second controller is going to cause an advertising packet to be transmitted by the wireless transceiver module. The WLAN controller responds by causing a first protection packet to be transmitted by the wireless transceiver module, said first protection packet causes all wireless devices receiving the protection packet to inhibit use of the wireless medium during a timer period which includes the advertising packet.

In another embodiment, the WLAN controller transmits a protection packet at the beginning of a scan window in which the second controller determines whether advertising packets are received. The second controller informs the WLAN controller whether an advertising packet was received during the scan window and whether the second controller responded to any such advertising packet. The WLAN controller transmits a contention free end packet based on the second controller receiving an advertising packet and transmitting a response to the advertising packet. The contention free end packet enables WLAN devices to use the wireless medium.

In yet another embodiment, the second controller sequentially listens for advertising packets on each of a plurality of advertising channels while the WLAN controller sends or receives WLAN packets. Based on the second controller detecting a packet in a particular advertising channel but unable to correctly decode the received packet, the WLAN controller inhibits further WLAN communications while the second controller switches to the next advertising packet in sequence to receive an advertising packet.

In another embodiment, the WLAN controller transmits a WLAN protection packet at or near the beginning of scan window during which the second controller attempts to detect reception of advertising packets. The second controller causes the WLAN controller to terminate a protection period instituted by the WLAN protection packet based on the second controller receiving an advertising packet during the scan window.

Corresponding methods are also described below.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 illustrates the use of advertising indicator packets to establish a connection in accordance with the Bluetooth Low Energy (BLE) protocol in various embodiments;

FIG. 3 illustrates the use of advertising directed indicator packets to establish a connection in accordance with the Bluetooth Low Energy (BLE) protocol in various embodiments;

FIG. 4 shows a method in accordance with some embodiments;

FIG. 5 illustrates the use of wireless local area network (WLAN) protection packets to protect BLE transmissions;

FIG. 6 illustrates another the use of wireless local area network (WLAN) protection packets to protect BLE transmissions; and

FIG. 7 illustrates another method in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct connection, or through an indirect connection via other devices and connections.

The terms “packet” and “frame” are used interchangeably in this disclosure.

### Detailed Description

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

This disclosure focuses on solutions to the coexistence problem of wireless local area network (WLAN) and Bluetooth Low Energy (BLE) technologies implemented in the same device. The BLE protocol has fairly unique issues in regards to its connection setup behavior. The disclosed embodiments take advantages of the unique activity patterns of BLE for efficient coexistence between WLAN and BLE.

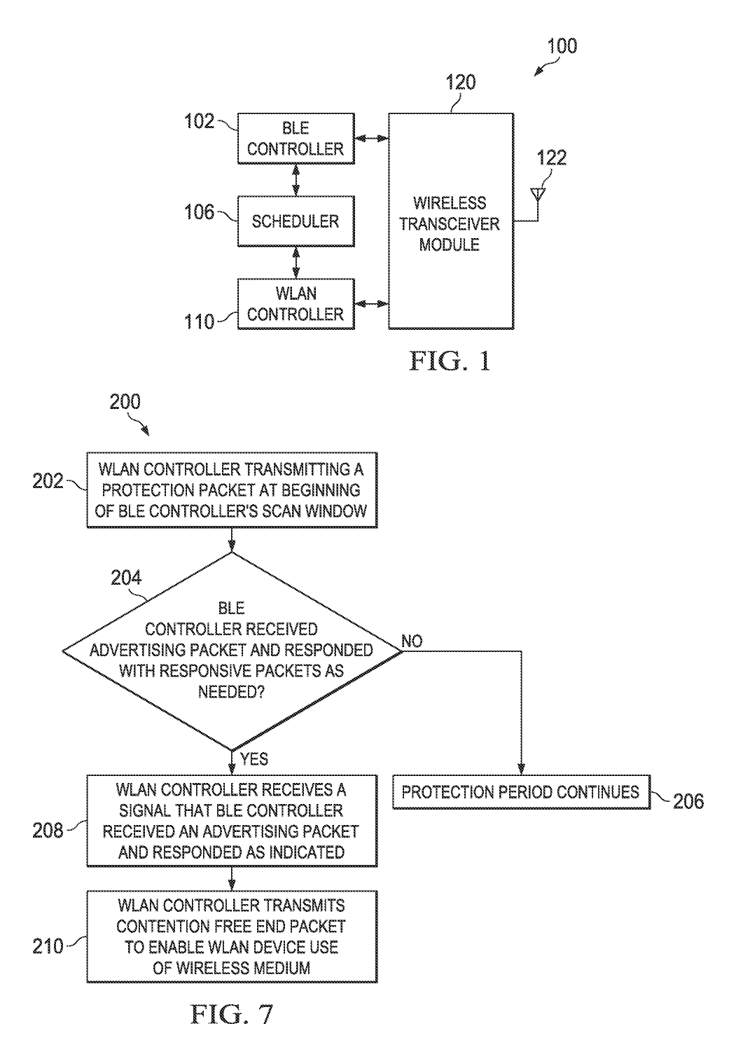

FIG. 1 shows a system 100 in accordance with various embodiments. The system 100 may be indicative of a smart phone, a computer or other type of electronic device. As shown, the system 100 includes two controllers 102 and 110 although more than two controllers can be included if desired. Each controller 102, 110 is able to send and receive wireless packets in accordance with a different wireless protocol. In the example shown in FIG. 1 and described herein, controller 102 is a Bluetooth Low Energy (BLE) controller and thus implements the BLE wireless protocol. Controller 110 is a WLAN controller and, as such, preferably implements one of the wireless protocols of the IEEE 802.11x family of protocols.

The BLE and WLAN controllers 102, 110 couple to a scheduler 106 and to a wireless transceiver module 120. One or more antennas 122 are connected to the wireless transceiver module 120 which may have multiple low noise amplifiers, transmitters and receivers. The scheduler 106 coordinates the activities of the BLE and WLAN controllers 102, 110 as explained below. The coordination implemented by the scheduler 106 permits both the BLE and WLAN wireless protocols to be implemented in the same system in an efficient manner. The scheduler 106 configures the BLE and WLAN controller 102 and 110 as described below.

In the BLE wireless protocol, two BLE-enabled devices are able to establish a connection between each other so that data and commands can be exchanged. When a connection is established, one BLE device is referred to as a “master” and the other BLE device is a “slave.” To establish a connection, a slave BLE device broadcasts advertising packets that are received and responded to by a master BLE device. The BLE protocol defines three channels that are used by slaves and masters for the transmission of the advertising packets and corresponding responses. The three channels are designated as channels 37, 38, and 39.

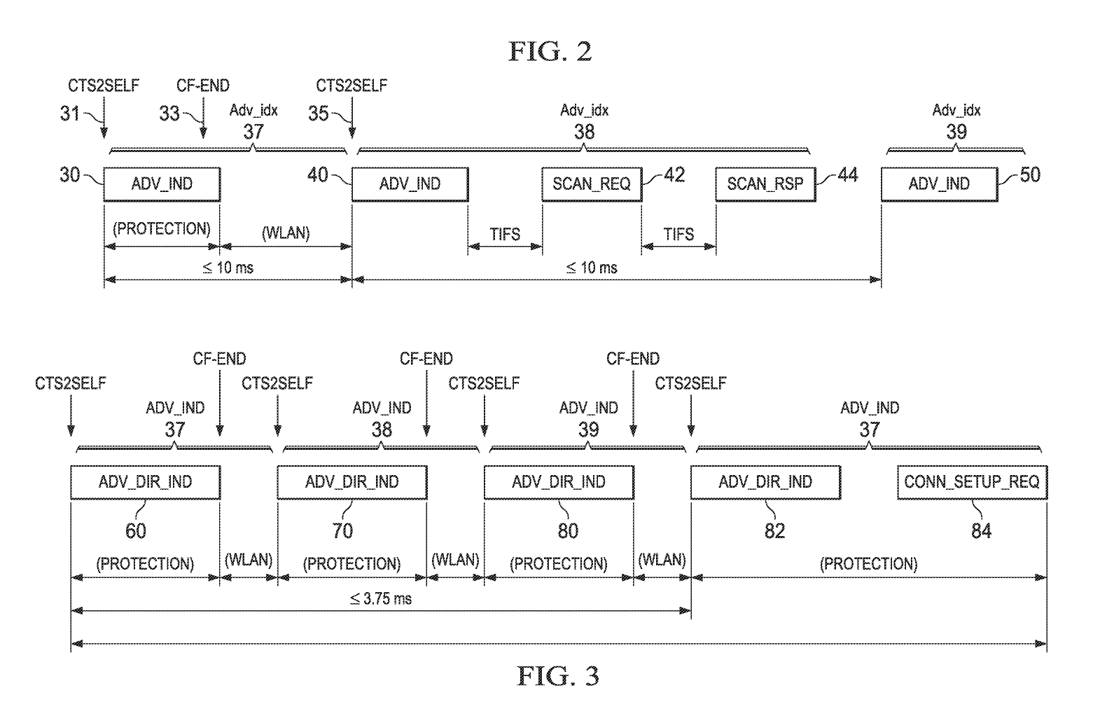

FIGS. 2 and 3 illustrate examples of a BLE master response to advertising packets from a BLE slave. FIG. 2 illustrates a slave device transmitting an advertising indicator (ADV_IND) packet in each of the three advertising channel indexes 37-39 dedicated for such purpose as noted above. And ADV_IND packet is not directed to any master device in particular. Transmitting an advertising packet in each of the three dedicated advertising channel indexes is referred to herein as a “round” of advertising packets. In FIG. 2, the master device does not respond to the advertising packets 30 and 50 in channel indexes 37 and 39, but does reply to the advertising packet 40 in channel index 38 with a scan request (SCAN_REQ) frame 42 requesting additional information from the slave device 20 in order to establish a connection. The slave responds with a scan response (SCAN_RSP) packet 44 to provide all such requested information.

As shown in the example of FIG. 2, the ADV_IND advertising packets 30, 40, and 50 are transmitted, one after the other but at an interval of at most 10 msec. Thus, a round of advertising packets takes at most 30 msec. After a slave device transmits an ADV_IND packet, the master may respond with a SCAN_REQ packet but must wait at least a transmit inter-frame spacing (TIFS) period of time (e.g., 150 microseconds) and must then transmit the SCAN_REQ packet within a predefined period of time thereafter.

In FIG. 3, the slave device sends directed advertising frames (ADV_DIR_IND) to a specific master device. A pair of master and slave devices may have already connected at some prior time; however, the connection may have been lost or ended for whatever reason. At any rate, the slave device wants to reestablish the connection to the same master device. In the example of FIG. 3, the master device does not reply to the first two ADV_DIR_IND frames 60 and 70 but does reply to the third ADV_DIR_IND frame 80 with a connection setup request frame (CONN_SETUP_REQ) 84 conveying connection specific information to slave.

As shown in the example of FIG. 3, the ADV_DIR_IND advertising packets 60-80 are transmitted with all three packets transmitted in a time period of 3.75 msec. Thus, a round of master-specific advertising packets takes at most 3.75 msec. As for the ADV_IND packets, after a slave device transmits an ADV_DIR_IND packet, the master may respond with a SCAN_REQ packet but must wait at least the TIFS period of time and must then transmit the CONN_SETUP_REQ packet within a predefined period of time thereafter (e.g., 150 microseconds).

### Slave

Referring again to FIG. 2, in accordance with the preferred embodiments of the invention, the WLAN controller 110 of a BLE slave protects some or all of the advertisement and connection setup phase implemented by the BLE controller 110. In a slave device, the BLE controller 102 informs the scheduler 106 when the BLE controller intends to cause an advertising frame (e.g., ADV_IND packet) to be transmitted. In response, the scheduler 106 informs the WLAN controller 110 that the WLAN controller should protect the ensuing period of time in which the BLE controller is going to transmit advertising packets and possibly receive responsive packets from BLE masters.

In response and as indicated at 31, the WLAN controller generates and causes a protection frame to be transmitted via wireless transceiver module 120. The protection frame may be a clear-to-send-to-self (CTS2Self) frame. A CTS2Self frame includes a protection time period set by the WLAN controller that generates the frame. Preferably, the protection time period extends for a period of time that covers the transmission of the advertising frames and any responsive frames from a master. In the embodiment of FIG. 3 for ADV_IND advertising frames transmitted by a BLE slave device, the protection time period may be, for example, 30 msec to cover the combined time in the three advertising channels 37-39.

However, if the BLE controller 102 does not receive a response from a master device within the predefined period of time following the TIFS time period, then the BLE controller informs the scheduler that no responsive packet was received. The WLAN controller 110 then can use the wireless medium for a period of time until the BLE controller 102 is to transmit the next advertising packet on another advertising channel. The scheduler 106 informs the WLAN controller 110 of this condition and the WLAN controller 110 generates and causes to be transmitted a contention free end (CF-End) packet at 33. The contention free end packet causes all WLAN devices receiving the packet to reset their network allocation vectors to thereby permit WLAN devices to use the wireless medium. At 35, the BLE controller 102 again desires to transmit an advertising packet, this time on advertising channel 38. The BLE controller 102 informs the scheduler of its intention and the scheduler causes the WLAN controller to quiesce the WLAN usage of the wireless medium with another CTS2Self protection frame. A similar process can be implemented for the ADV_DIR_IND advertising packets in FIG. 3.

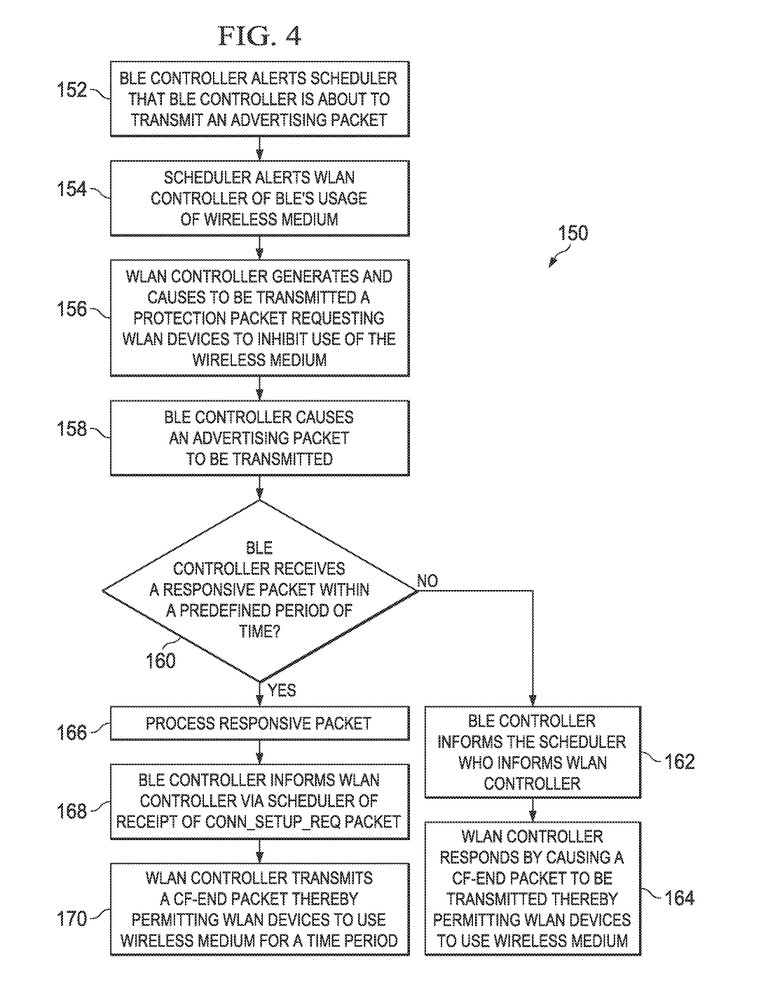

FIG. 4 shows a corresponding method 150 in accordance with various embodiments. The actions in FIG. 4 can be performed in the order shown or in a different order and two or more of the actions can be performed in parallel rather than sequentially. At 152, the method comprises the BLE controller alerting the scheduler that the BLE controller is about to transmit an advertising packet. At 154, the scheduler alerts the WLAN controller of the BLE controller's usage of the wireless medium of connection setup purposes. In some embodiments, the scheduler simply asserts a signal to the WLAN controller to transmit a protection frame without informing the WLAN controller as to the reason.

At 156, the WLAN controller generates and causes to be transmitted a protection packet requesting WLAN devices that receive the protection packet to inhibit use of the wireless medium. At 158, the method comprises the BLE controller causing an advertising packet to be transmitted. At 160, the BLE controller determines whether a responsive packet (e.g., a CONN_SETUP_REQ or SCAN_REQ packet) is received within the defined period of time (within a specific period of time following the TIFS time period). If no such response is received, then at 162 the BLE controller 102 informs the scheduler 106 (who in turn informs the WLAN controller 110) that no responsive packet was received. As a result, at 164, the WLAN controller 110 causes a CF-End packet to be transmitted thereby permitting WLAN devices to use the wireless medium without interfering with any BLE packets.

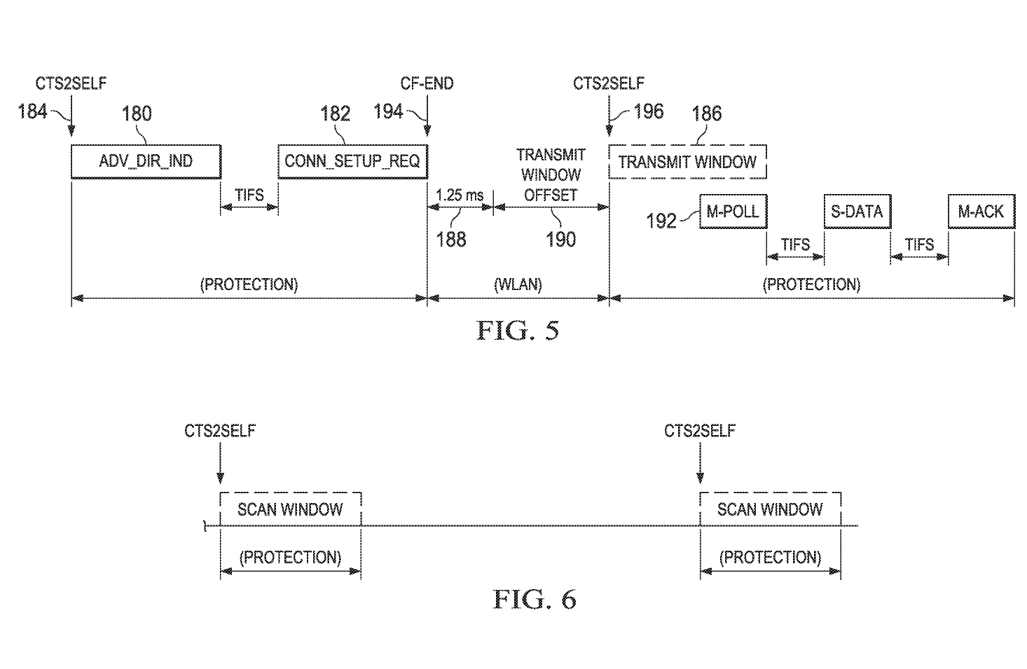

FIG. 5 illustrates a ADV_DIR_IND packet 180 transmitted by a BLE slave followed by receipt of a master's CONN_SETUP_REQ packet 182 after a TIFS period of time. As explained above, the WLAN controller 110 previously transmitted a CTS2Self frame 184 at or just before the BLE controller 102 began to transmit the ADV_DIR_IND packet 180. A protection period ensues until the BLE controller receives the CONN_SETUP_REQ packet 182 at which time, via the scheduler 106, the WLAN controller transmits a CF-End packet to terminate the protection implemented by the CTS2Self packet. In accordance with the BLE protocol, a transmit window 186 opens up following a 1.25 msec period of time 188 and a transmit window offset 190. The transmit window offset may be specified by CON_SETUP_REQ. The BLE controller awaits a master poll packet (M-Poll) 192 during the transmit window. The M-Poll packet dictates whether a read or write of data is to occur between master and slave. Between the time the CONN_SETUP_REQ packet is received by the BLE controller in the slave and the time the transmit window begins, use of the wireless medium may be granted to WLAN devices as the BLE is not using the wireless medium during that time period anyway. As such, the scheduler 106 informs the WLAN controller that it can end the protection period and the WLAN controller broadcasts a contention free end packet at 194 to permit WLAN devices to use the wireless medium. At 196, the scheduler alerts the WLAN controller that it must quiesce WLAN device usage of the wireless medium (because the transmit window 186 is about to begin), and the WLAN controller transmits a protection packet at 196 to protect the BLE controller's usage of the wireless medium during the transmit window and any subsequent S-Data and M-Ack packets.

Returning to FIG. 4, if the BLE controller 102 does receive a response to its advertising packet, then at 166, the responsive packet is processed by the BLE controller in accordance with the BLE protocol. The responsive packet may be a CONN_SETUP_REQ packet in the case of ADV_DIR_IND advertising packets. In that case and as shown at 168 in FIG. 4 and discussed above with regard to FIG. 5, the BLE controller also alerts the WLAN controller 110 (by way of the scheduler 106) that it has received a CONN_SETUP_REQ packet. At 170, the WLAN controller transmits a CF-End packet thereby permitting WLAN devices to use the wireless medium for a period of time (e.g., for 1.25 msec plus the transmit window offset).

FIG. 5 illustrates a data packet exchange between BLE slave and master devices, although multiple data packets may be exchanged between slave and master devices as well, and the WLAN protection period should be set to cover the entire period in which BLE packets may be exchanged. Further, it is possible that a BLE packet is not correctly received and is then retransmitted. The value p is the probability that a packet will be sent and/or received in error. The error probability p may be measured or estimated dynamically or pre-programmed into the system 100. The error probability p may be provided to the WLAN controller. Given timing constraints, it may be difficult for the system 100 to switch from BLE mode to WLAN to enable the WLAN controller to transmit another protection frame to extend the protection period. In accordance with the preferred embodiments, the protection time period calculated for and included in the CTS2Self frame 196 is a function of the error probability p. For example, the protection time period may be computed as:

Protection time period=(M-Poll duration+S-Data duration)/(1−p)

### Master

A system 100 may function as a BLE master as noted above. As a BLE master and as shown in FIG. 6, the BLE controller 102 implements a scan window at regular intervals. During each scan window, the BLE controller 102 searches for the presence of an advertising packet sent by a slave BLE device in each of the three advertising channels 37-39. To avoid contention between the master's BLE controller 102 and a WLAN controller 110 internal to the same device, the scheduler 106 causes the WLAN controller 110 to transmit a protection frame (e.g., CTS2Self packet) at or near the beginning of each scan window as shown in FIG. 6. Each CTS2Self packet institutes a WLAN protection period for the duration of the BLE-based scan window.

The WLAN protection period created for the BLE master scan windows can be terminated early in certain situations in accordance with various embodiments. For example, if the BLE master controller 102 receives an advertising packet in a particular advertising channel and responds appropriately (e.g., SCAN_REQ packet or CONN_SETUP_REQ packet), the WLAN protection period can be terminated at that point and not continue for the entire BLE scan window.

FIG. 7 illustrates a corresponding method 200. The actions in FIG. 4 can be performed in the order shown or in a different order and two or more of the actions can be performed in parallel rather than sequentially. At 202, the WLAN controller transmits a protection packet (e.g., CTS2Self) at or near the beginning of a BLE controller's scan window. At 204, the BLE controller 102 determines whether it receives an advertising packet from a slave BLE. If no such advertising packet is received by the master BLE controller, then at 206 the protection period instituted by the protection frame transmitted in 202 continues.

If, however, the master BLE device receives an advertising packet during a scan window, then once the BLE controller responds with a responsive packet as needed, the BLE controller informs its scheduler 106 which in turn informs the WLAN controller 110. The scheduler 106 asserts a signal to the WLAN controller 110 which indicates that the protection period can be terminated. At 208, the WLAN controller receives the signal from the scheduler 106 that the BLE controller received an advertising packet and responded as indicated. At 210, the WLAN controller transmits a contention free end packet to enable WLAN device usage of the wireless medium.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An apparatus, comprising:
a wireless local area network (WLAN) controller configured to cause a wireless transceiver module to send and receive packets over a wireless medium; and
a second controller coupled to the WLAN controller and also configured to cause the wireless transceiver module to send and receive packets;
wherein the second controller informs the WLAN controller that the second controller is going to cause an advertising packet to be transmitted by the wireless transceiver module; and
wherein the WLAN controller responds by causing a first protection packet to be transmitted by the wireless transceiver module, said first protection packet causes all wireless devices receiving the protection packet to inhibit use of the wireless medium during a timer period which includes the advertising packet.

2. The apparatus of claim 1 wherein the second controller is a Bluetooth Low Energy (BLE) controller.

3. The apparatus of claim 1 wherein based on the second controller failing to receive a responsive packet to the advertising packet within a predefined period of time, the second controller informs the WLAN controller that the WLAN controller can access the wireless medium.

4. The apparatus of claim 3 wherein the WLAN controller responds to the second controller informing the WLAN controller that the WLAN controller can access the wireless medium by causing a contention free end packet to be transmitted thereby permitting WLAN devices to use the wireless medium.

5. The apparatus of claim 1 wherein based on the second controller receiving a responsive packet to the advertising packet within a predefined period of time, the WLAN controller causes a contention free end packet to be transmitted thereby permitting WLAN devices to use the wireless medium for a first period of time.

6. The apparatus of claim 5 wherein the first period of time is computed based on a transmit window offset.

7. The apparatus of claim 5 wherein the WLAN controller causes a second protection packet to be sent upon expiration of the first period of time.

8. The apparatus of claim 7 wherein the WLAN controller includes a protection period of time in the second protection packet, said protection period of time computed by the WLAN controller as a function of a packet error probability.

9. A method, comprising:
alerting, by a second controller, a wireless local area network (WLAN) controller in a wireless device that the second controller is going to cause an advertising packet to be transmitted by a wireless transceiver module;
responding, by the WLAN controller, to the alert by causing a first protection packet to be transmitted by the wireless transceiver module, said first protection packet causing all wireless devices receiving the protection packet to inhibit use of the wireless medium during a timer period which includes the advertising packet.

10. The method of claim 9 further comprising:
transmitting the advertising packet by the second controller;
determining, by the second controller, whether the second controller has received a responsive packet to the advertising packet within a predefined period of time; and
informing, by the second controller, the WLAN controller whether the second controller received the responsive packet.

11. The method of claim 10 wherein, based on the WLAN controller being informed that the second controller did not receive the responsive packet, the WLAN controller causing a contention free end packet to be wirelessly transmitted thereby permitting WLAN devices to use the wireless medium.

12. The method of claim 9 wherein, based on the WLAN controller being informed that the second controller received the responsive packet, transmitting by the WLAN controller a contention free end packet to be transmitted thereby permitting WLAN devices to use the wireless medium for a first period of time that is computed based on a transmit window offset.

13. The method of claim 12 further comprising transmitting, by the WLAN controller, a second protection packet upon expiration of the first period of time.

14. The method of claim 13 further comprising:
computing, by the WLAN controller a protection period of time based on a packet error probability; and
specifying in the second protection packet the protection period of time.

15. An apparatus, comprising:
a wireless local area network (WLAN) controller configured to cause a wireless transceiver module to send and receive packets over a wireless medium; and
a second controller coupled to the WLAN controller and also configured to cause the wireless transceiver module to send and receive packets;
wherein the WLAN controller transmits a protection packet at the beginning of a scan window in which the second controller determines whether advertising packets are received, and wherein the second controller informs the WLAN controller whether an advertising packet was received during the scan window and whether the second controller responded to any such advertising packet;
wherein the WLAN controller transmits a contention free end packet based on the second controller receiving an advertising packet and transmitting a response to the advertising packet, the contention free end packet enables WLAN devices to use the wireless medium.

16. The apparatus of claim 15 wherein the second controller is a Bluetooth Low Energy (BLE) controller.

17. The apparatus of claim 15 wherein the WLAN controller transmits a contention free end packet based on the second controller receiving an advertising directed indicator packet and transmitting a responsive connection setup request packet.

18. The apparatus of claim 15 wherein the WLAN controller transmits a contention free end packet based on the second controller receiving an advertising indicator packet, receiving a scan request packet, and transmitting a scan response packet if requested.

19. A method, comprising:
transmitting, by a wireless local area network (WLAN) controller a protection packet at the beginning of a scan window for a second controller;
determining, by the second controller, whether an advertising packet was received during the scan window;
receiving, by the WLAN controller, a signal that the second controller received an advertising packet and responded as indicated; and
based on receipt of the signal, transmitting, by the WLAN controller, a contention free end packet that enables WLAN devices to use the wireless medium.

20. The method of claim 19 wherein said determining includes determining, by the second controller, whether an advertising directed indicator packet was received, and said signal indicates that an advertising directed indicator packet was received and the second controller responded with a connection setup request packet, and wherein transmitting the contention free end packet is based on the second controller receiving the advertising directed indicator packet and having transmitted the connection setup request packet.

21. The method of claim 19 wherein said determining includes determining, by the second controller, whether an advertising indicator packet was received, and said signal indicates that an advertising directed indicator packet was received and the second controller responded with a scan response packet, and wherein transmitting the contention free end packet is based on the second controller receiving the advertising indicator packet and having transmitted the scan response packet.

22. An apparatus, comprising:
a wireless local area network (WLAN) controller configured to cause a wireless transceiver module to send and receive packets over a wireless medium in accordance with a first wireless protocol; and
a second controller coupled to the WLAN controller and also configured to cause the wireless transceiver module to send and receive packets in accordance with a second wireless protocol;
wherein the second controller sequentially listens for advertising packets on each of a plurality of advertising channels while the WLAN controller sends or receives WLAN packets and based on the second controller detecting a packet in a particular advertising channel but unable to correctly decode the received packet, the WLAN controller inhibits further WLAN communications while the second controller switches to the next advertising packet in sequence to receive an advertising packet.

23. The apparatus of claim 22 wherein the WLAN controller inhibits further WLAN communications by not transmitting WLAN packets.

24. The apparatus of claim 22 wherein the WLAN controller inhibits further WLAN communications by transmitting a protection packet that inhibits all WLAN devices from transmitting on the wireless medium.

25. A method implemented in a device containing a wireless local area network (WLAN) controller, a second wireless controller, an a wireless transceiver, comprising:
configuring the second controller to detect wireless advertising packets on each of a plurality of advertising channels in accordance with a second wireless protocol;
while the second controller is configured to detect advertising packets, the WLAN controller sending or receiving WLAN packets in accordance with a WLAN protocol;
detecting, by the second controller, but not correctly decoding an advertising packet in one of the advertising channels;
causing the WLAN controller to inhibit WLAN communications; and
configuring the second controller to switch to another advertising channel and detect and correctly receive another advertising packet.

26. The method of claim 25 wherein causing the WLAN controller to inhibit further WLAN communications comprises preventing the WLAN controller from transmitting WLAN packets.

27. The method of claim 25 wherein causing the WLAN controller to inhibit further WLAN communications comprises transmitting a protection packet that inhibits all WLAN devices from transmitting on the wireless medium.

28. An apparatus, comprising:
a wireless local area network (WLAN) controller configured to cause a wireless transceiver module to send and receive packets over a wireless medium in accordance with a first wireless protocol; and
a second controller coupled to the WLAN controller and also configured to cause the wireless transceiver module to send and receive packets in accordance with a second wireless protocol;
wherein the WLAN controller transmits a WLAN protection packet at or near the beginning of scan window during which the second controller attempts to detect reception of advertising packets; and
wherein the second controller causes the WLAN controller to terminate a protection period instituted by the WLAN protection packet based on the second controller receiving an advertising packet during the scan window.

29. The apparatus of claim 28 wherein the second controller causes the WLAN controller to terminate the protection period based on the second controller receiving an advertising packet during the scan window and also transmitting a packet in response to the received advertising packet.

30. A method, comprising:
transmitting, by a wireless local area network (WLAN) controller, a WLAN protection packet in accordance with a WLAN protocol at or near a beginning of a scan window;
determining whether an advertising packet is received during the scan window in accordance with a second wireless protocol;
based on a reception of an advertising packet during the scan window, terminating early a protection period instituted by the protection packet.

31. The method of claim 30 wherein terminating early the protection period includes transmitting, by the WLAN controller, a contention free end packet.
